(19) United States
(12) Patent Application Publication
(10) Pub. No.: US 2022/0024045 A1
(43) Pub. Date: Jan. 27, 2022

(54) Intelligent defense protection method and intelligent dart protection robot

(71) Applicant: Yuesong Zhang, Guangzhou (CN)

(72) Inventor: Yuesong Zhang, Guangzhou (CN)

(21) Appl. No.: 17/450,557

(22) Filed: Oct. 12, 2021

(30) Foreign Application Priority Data
Dec. 25, 2020 (CN) 202011558445.3

(51) Int. Cl. B25J 11/00; B25J 19/02; G06K 9/00

(52) U.S. Cl. CPC B25J 11/002; B25J 19/023; G06K 9/00744; G06K 9/00302; G06K 9/00342; G06K 9/00355; G06K 9/00375

(57) ABSTRACT

The invention provides an intelligent defense protection method and intelligent dart protection robot, due to the fact that the video information of the living organism is continuously collected in a specified range, and whether the dangerous attack behaviors exist in the living organism in the specified range or not is analyzed; moreover, if the living organism is judged to be a dangerous living organism, a distance measuring operation is firstly carried out so as to measure that the distance DR between the dangerous living organism and the protected object is within the level range of the dangerous attack degree range DL, thereby executing the corresponding level of the defense protection operation and avoiding the problem of improper defense or heavy defense.

### TECHNICAL FIELD

The invention relates to the technical field of security, in particular to an intelligent defense protection method and intelligent dart protection robot.

### BACKGROUND

At present, most of the darts known by us are men who are trained specially, and besides certain combat skills, the darts also have other additional skills, such as reconnaissance judgment, safety distribution, information collection, security measures, crisis prevention, dangerous situation evacuation and other aspects of comprehensive ability. Although the dart can undertake some defensive work, it is necessary to respond timely and make appropriate defensive operations for the assault, but the sensitivity and judgment of mankind are still lacking. At the same time, it is difficult for people to learn and master the recognition judgment for quickly and accurately identifying potential dangerous persons.

Therefore, it is necessary to provide a technical means to solve the above-mentioned problems.

### SUMMARY

The invention aims to overcome the defects of the prior art, and provides an intelligent defense protection method and intelligent dart protection robot so as to solve the problems that human darts in the prior art are difficult to deal with sudden attacks and identify potential dangerous persons quickly and accurately.

In order to solve the above technical problem, the embodiments of the present application provide an intelligent defense protection method, comprises the following steps:

acquiring the video information of the living organism in a specified range, wherein the video information comprises limb action information and facial micro-expression information;

inputting the collected video information of the living organism into a risk analysis database to calculate and analyze whether the living organism in the specified range has dangerous attack behaviors, defining the living organism analyzed for the existence of the dangerous attack behaviors as a dangerous living organism, and defining the living organism analyzed for the absence of the dangerous attack behaviors as a non-dangerous living organism;

if the living organism is judged to be a non-dangerous living organism, a defense protection operation is not executed;

if the living organism is judged to be a dangerous living organism, a distance measuring operation is performed to measure the distance D_{R} between the dangerous living organism and the protected object, then the distance D_{R} is substituted into the set dangerous attack degree range D_{L}, and it is determined that the distance D_{R} belongs to the level range of the dangerous attack degree range D_{L};

executing the corresponding defense protection operation according to the level range of the distance D_{R} within the dangerous attack degree range D_{L};

wherein the dangerous attack degree range D_{L} comprises a weak attack danger range D_{W}, a medium attack danger range D_{M} and a serious attack danger range D_{S}, D_{W}≥D_{M}≥D_{S}, D_{R}∈[D_{W}, D_{M}, D_{S}];

the defense protection operation comprises a first-level defense protection operation for warning prompt, a second-level defense protection operation for protecting the object and warning the dangerous living organism, and a third-level defense protection operation for protecting the object and stimulating to retreat the dangerous living organism;

if the distance D_{R} belongs to the weak attack danger range D_{W}, executing the first-level defense protection operation;

if the distance D_{R} belongs to the medium attack danger range D_{M}, executing the second-level defense protection operation;

if the distance D_{R} belongs to the serious attack danger range D_{S}, executing the third-level defense protection operation.

The invention also provides an intelligent dart protection robot, which comprises:

a robot body comprises a body, a head, a left arm, a right arm, a left leg and a right leg, wherein the head is rotatably arranged at the upper end of the body, the left arm is movably arranged at one side end of the body, the right arm is movably arranged at the other side end of the body, and the left leg is movably arranged at one side end of the lower end of the body, the right leg is movably arranged on the other side end of the lower end of the body;

an acquisition unit is arranged in the head and used for acquiring the video information of the living organism in a specified range; the video information comprises limb action information and facial micro-expression information;

a distance measurement unit is arranged in the head and used for measuring the distance D_{R} between the dangerous living organism and the protected object, then substituting the distance D_{R} into the set dangerous attack degree range D_{L}, and judging that the distance D_{R} belongs to the level range of the dangerous attack degree range D_{L}; the dangerous attack degree range D_{L} comprises a weak attack danger range D_{W}, a medium attack danger range D_{M} and a serious attack danger range D_{S}, D_{W}≥D_{M}≥D_{S}, D_{R}∈[D_{W}, D_{M}, D_{S}];

a defense protection device is arranged on the robot body and used for executing the corresponding defense protection operation according to the level range of the distance D_{R} within the dangerous attack degree range D_{L}; the defense protection device comprises a first-level defense protection module used for warning prompt, a second-level defense protection module used for protecting the object and warning the dangerous living organism, and a third-level defense protection module used for protecting the object and stimulating to retreat the dangerous living organism, when the distance D_{R} belongs to the weak attack danger range D_{W}, the first-level defense protection module executes the first-level defense protection operation, when the distance D_{R} belongs to the medium attack danger range D_{M}, the second-level defense protection module executes the second-level defense protection operation, and when the distance D_{R} belongs to the serious attack danger range D_{S}, the third-level defense protection module executes the third-level defense protection operation;

a control system is arranged inside the body and is respectively connected with the acquisition unit, the distance measurement unit and the defense protection device, and used for controlling the acquisition unit, the distance measurement unit and the defense protection device to work; the control system includes a risk analysis database module for calculating and analyzing whether the living organism in the specified range has dangerous attack behaviors, defining the living organism analyzed for the existence of the dangerous attack behaviors as a dangerous living organism, and defining the living organism analyzed for the absence of the dangerous attack behaviors as a non-dangerous living organism.

According to the technical solution provided by the present application, due to the fact that the video information of the living organism is continuously collected in a specified range, specifically, limb motion information and facial micro-expression information of the living organism are analyzed, and whether the dangerous attack behaviors exist in the living organism in the specified range or not is analyzed; moreover, if the living organism is judged to be a dangerous living organism, a distance measuring operation is firstly carried out so as to measure that the distance D_{R} between the dangerous living organism and the protected object is within the level range of the dangerous attack degree range D_{L}, thereby executing the corresponding level of the defense protection operation and avoiding the problem of improper defense or heavy defense. In this way, for a sudden attack, an appropriate defense operation can be timely reflected and executed, so that the object can be timely protected and the attacker can be effectively knocked back. Meanwhile, potential dangerous persons and dangerous animals can be quickly and accurately identified, so that the defense protection operation can be carried out early, and attack and injury are effectively avoided.

### BRIEF DESCRIPTION OF THE DRAWINGS

To better describe the technical solution in the embodiments of the present application, accompanying drawings needed in the implementation are simply illustrated below; obviously, accompanying drawings described hereinafter illustrate some implementations of the present application; for the ordinary skill in the field, other accompanying drawings may be obtained according to these accompanying drawings without creative work.

FIG. 1 is a flow diagram of the intelligent defense protection method according to an embodiment of the present invention;

FIG. 2 is a schematic diagram of a risk analysis database in the intelligent defense protection method according to an embodiment of the present invention performing computational analysis on video information of the collected living organisms;

FIG. 3 is a schematic diagram comparing dangerous living organism with non-dangerous living organism in the intelligent defense protection method according to an embodiment of the present invention;

FIG. 4 is a schematic diagram of the intelligent dart protection robot according to an embodiment of the present invention;

FIG. 5 is a schematic view illustrating an operation principle of the intelligent dart protection robot according to an embodiment of the present invention;

FIG. 6 is a schematic diagram of control components of a control system of the intelligent dart protection robot according to an embodiment of the present invention.

### DESCRIPTION OF THE EMBODIMENTS

A clear and complete description as below is provided to the technical scheme in the embodiments of the present application in conjunction with the accompanying drawings in the embodiments of the present application. It should be appreciated that the embodiments described hereinafter are simply part embodiments of the present application, but all the embodiments. All other embodiments obtained by the ordinary skill in the art based on the embodiments in the present application without creative work are intended to be included in the scope of protection of the present application.

In the description of the embodiments of the present application, it should be appreciated that directional or positional relations indicated by terms such as “thickness”, “left”, “right”, “up”, “down”, etc. are directional or positional relations shown based on the drawings, merely to conveniently describe the present application and simplify the description, but not to indicate or imply the designated device or element to be constructed and operated in a specific position or in a specific direction; therefore, the used directional terms cannot be understood as a restriction to the present application.

### First Embodiment

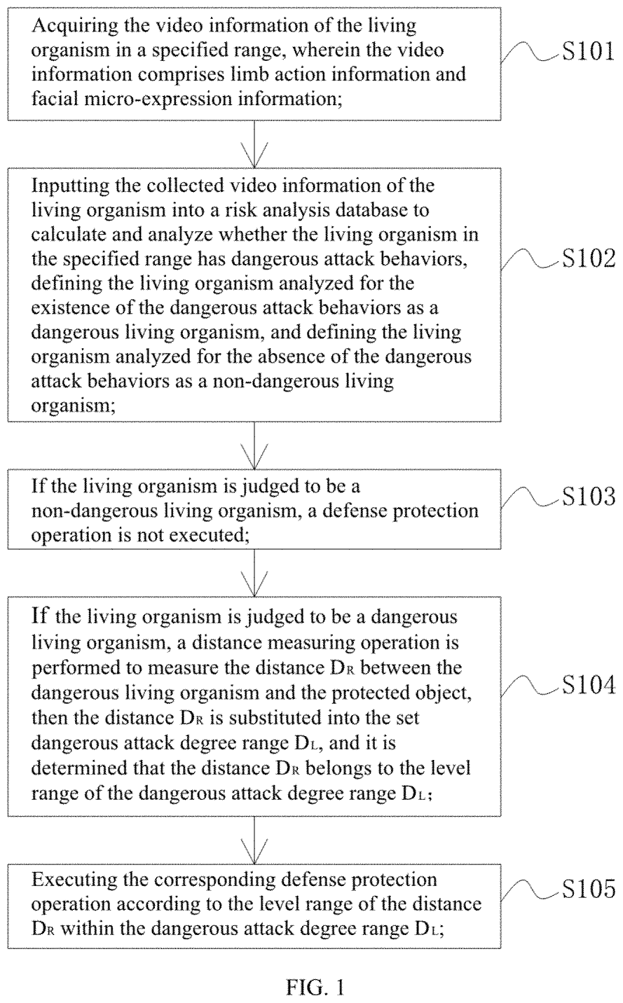

Referring to FIGS. 1 to 3, a preferred embodiment of the present invention relates to an intelligent defense protection method, comprises the following steps:

step S101, acquiring the video information of the living organism in a specified range, wherein the video information comprises limb action information and facial micro-expression information, while the specified range is a circular range with the protected object as the center and a radius of 10 m;

step S102, inputting the collected video information of the living organism into a risk analysis database to calculate and analyze whether the living organism in the specified range has dangerous attack behaviors, defining the living organism analyzed for the existence of the dangerous attack behaviors as a dangerous living organism, and defining the living organism analyzed for the absence of the dangerous attack behaviors as a non-dangerous living organism;

step S103, if the living organism is judged to be a non-dangerous living organism, a defense protection operation is not executed;

step S104, if the living organism is judged to be a dangerous living organism, a distance measuring operation is performed to measure the distance D_{R} between the dangerous living organism and the protected object, then the distance D_{R} is substituted into the set dangerous attack degree range D_{L}, and it is determined that the distance D_{R} belongs to the level range of the dangerous attack degree range D_{L};

step S105, executing the corresponding defense protection operation according to the level range of the distance D_{R} within the dangerous attack degree range D_{L};

wherein the dangerous attack degree range D_{L} comprises a weak attack danger range D_{W}, a medium attack danger range D_{M} and a serious attack danger range D_{S}, D_{W}≥D_{M}≥D_{S}, D_{R}∈[D_{W}, D_{M}, D_{S}];

the defense protection operation comprises a first-level defense protection operation for warning prompt, a second-level defense protection operation for protecting the object and warning the dangerous living organism, and a third-level defense protection operation for protecting the object and stimulating to retreat the dangerous living organism;

if the distance D_{R} belongs to the weak attack danger range D_{W}, executing the first-level defense protection operation;

if the distance D_{R} belongs to the medium attack danger range D_{M}, executing the second-level defense protection operation;

if the distance D_{R} belongs to the serious attack danger range D_{S}, executing the third-level defense protection operation.

Due to the fact that the video information of the living organism is continuously collected in a specified range, specifically, limb motion information and facial micro-expression information of the living organism are analyzed, and whether the dangerous attack behaviors exist in the living organism in the specified range or not is analyzed; moreover, if the living organism is judged to be a dangerous living organism, a distance measuring operation is firstly carried out so as to measure that the distance D_{R} between the dangerous living organism and the protected object is within the level range of the dangerous attack degree range D_{L}, thereby executing the corresponding level of the defense protection operation and avoiding the problem of improper defense or heavy defense.

In this way, for a sudden attack, an appropriate defense operation can be timely reflected and executed, so that the object can be timely protected and the attacker can be effectively knocked back. Meanwhile, potential dangerous persons and dangerous animals can be quickly and accurately identified, so that the defense protection operation can be carried out early, and attack and injury are effectively avoided.

It should be noted that it is based on the following principle that whether there is a dangerous attack behaviors of a living organism corresponding to the facial micro-expression of the living organism:

The particle is a matter of physics and there is no clear boundary between the particle properties, and the photon energy (ε) is connected by the known Planck constant photon energy and frequency (ν), and the formula is ε=h ν. Hypothesis of the frequency of vibration at the site and this ratio in the energy space emitted by the organism and the site. By conclusion, it is necessary to record the vibration from multiple parts of the organism (in space or between each site). This process needs to be implemented by a contactless TV system that guarantees efficient resolution and fast processing power. In addition, the frequency component of acquiring a biological signal image (i. E. the frequency of vibrations (position changes, fluctuations) generated at each site) is the observed biological energy, i. E. the vast information that possesses psychophysiological properties. Bio-signal image analysis can also be performed by humans or mathematically by programmatic processing of digital bio-signal images and specific elements. The algorithm of mathematical processing creates and analyzes a color-like video stream of the monitor display or visually analyzes the biological signal image mode most effectively. In other words, the biosignal image frequency component that needs to be derived is the state of human psychophysiological characteristics and the level of persistent emotional state to clearly recognize the change of human body state caused by various human stimuli. All thoughts and actions or in any case the changes that occur instantaneously in relation to the reaction emotional state (per biosignal image) are continuous, so it is very important to be able to find an optimal relation between the information number of the biosignal image (camera resolution) and the system that can be processed quickly. The amplitude modulating of the increase in the vibration image is the average value of the frequency or amplitude of the position change generated in a specific region of the human body with the target maximum vibration frequency, and any change in the psychophysiological characteristics of the human body shown through the color modulating is recorded at a clear moment. Fractal fluctuation is the most important way to realize learning, memory and solving many problems. According to the experiment, the most concentrated part of human body vibration is the brain, and most of the frequency components of vibration images are that the image around the head is larger than the vibration image around the body. The changes generated by human body are displayed in such a way that the vibration image is uneven or the color morphology is asymmetric. This can be seen by looking at the bio-signal image. According to the experimental results, it occurs that the most signal is the frequency average level of maximum vibration frequency transmission of human emotional state or the background level between adjacent points is blurred or the real change generated when the visualization of biological signal image is received is concealed. Amplitude components other than frequency components are more efficient than geometrically related. What is most important is that the geometrically connected bio-signal image amplitudes of the vibration point sites constitute the desired quality assessment of the bio-signal image and the establishment of more accurately determined parameters for system adjustment.

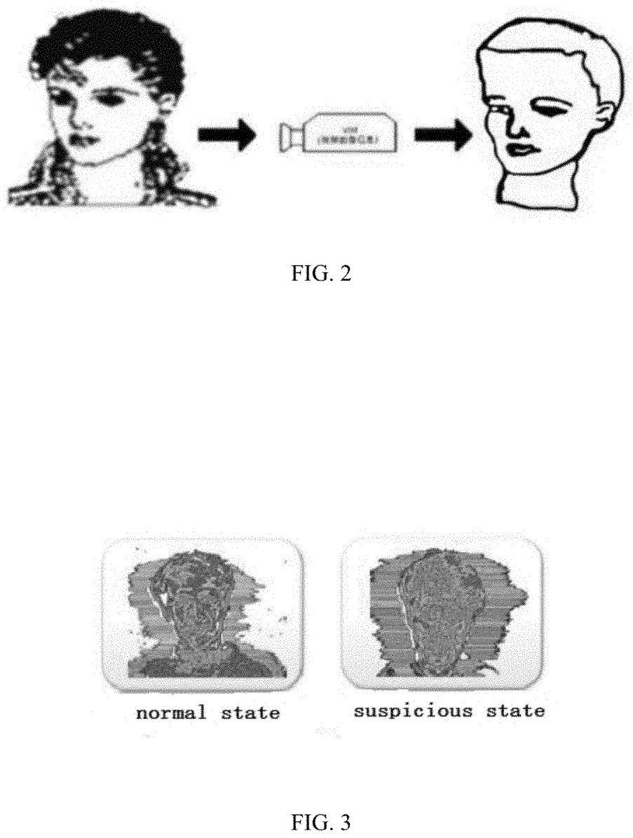

Referring to FIGS. 2 to 3, when the living organism is a human, the determination of the dangerous attack behavior is based on the following:

step S201, extracting a plurality of video frames of a human limb action in video information at intervals of a pre-set time of 5 seconds, identifying positions and gestures of the human in the plurality of video frames, then calculating an attack probability G_{R} of the human attacking the protected object according to the relevant information about the positions and gestures of the human by a time sequence analysis model, and judging whether the attack probability G_{R} reaches a threshold value G_{L}, wherein if G_{R} [symbol] G_{L}, the human has a dangerous attack behaviour, and if G_{R}<G_{L}, the human does not have the dangerous attack behaviour;

step S202, and/or extracting a plurality of video frames of a human facial micro-expression in the video information at intervals of a pre-set time of 5 seconds, substituting relevant information about the human facial micro-expression of the pluralities of video frames into a pre-set calculation formula of an attack degree D_{A} so as to acquire a numerical value of the attack degree D_{A}, and then judging whether the attack degree D_{A} reaches a threshold value D_{L}, wherein if D_{A} [symbol] D_{L}, the human has a dangerous attack behaviour, and if D_{A}<D_{L}, the human does not have the dangerous attack behaviour, wherein the calculation formula of the attack degree D_{A} in the facial micro-expression is:

$${D}_{A} = \frac{1}{2} [ \frac{{F}_{M} + 4 \times \sqrt{\frac{1}{N}} {\sum }_{1}^{N} {( {F}_{i} - \overline{F} )}^{2}}{2 F i n} + \frac{\frac{{\sum }_{1}^{k} ( \frac{\vert {A}_{L}^{i} - {A}_{R}^{i} \vert}{{A}_{max}^{i}} + \frac{\vert {F}_{L}^{i} - {F}_{R}^{i} \vert}{{F}_{max}^{i}} )}{2 n} + \frac{{{\sum }^{{f}_{max}}}_{\frac{{f}_{max} + {f}_{min}}{2}} {P}_{i} ( f )}{{\sum }_{0 , 1}^{{f}_{max}} {P}_{i} ( f )}}{2} ]$$

F_{M} is the maximum frequency of the frequency distribution density histogram;

Fᵢ is obtaining a statistical calculation number of the frequency number of the histogram i of the frequency distribution density for 50 frames per time period;

Fin is the vibration image processing frequency;

N is 50 frames and there is also a high limit value for the statistical calculation of the difference between frames;

A_{L}ⁱ is the total amplitude of the “I” thermal vibration image of the left part of the target;

A_{R}ⁱ is the total amplitude of the “I” thermal vibration image of the right part of the target;

Aₘₐₓⁱ−A_{L}ⁱ is the maximum value from start to A_{R}ⁱ;

F_{L}ⁱ is the maximum frequency of the “I” vibration image of the left part of the target;

F_{R}ⁱ is the maximum frequency of the “I” thermal vibration image of the right part of the target;

Fₘₐₓⁱ−F_{L}ⁱ is the maximum value from start to F_{R}ⁱ;

n is the maximum target heating value;

Pᵢ(f) is the vibration image frequency diffusion dynamic spectrum;

fₘₐₓ is the maximum frequency of frequency diffusion spectrum of vibration image;

fₘᵢₙ is the vibration image frequency spread spectrum minimum frequency.

For all these aggressiveness levels, it is clear that the lower aggressiveness state has a value close to 0 and the higher aggressiveness state has a value close to 1.

Wherein the threshold value D_{L} of the present embodiment is set to 65.5%, and when D_{A}=60%, D_{A}<D_{L}, then the human has no dangerous attack behavior; and when D_{A}=70%, D_{A}>D_{L}, then the human has dangerous attack behavior.

Preferably, the calculation of the attack probability G_{R} comprises:

Using a binary group (W_{R}, Z_{R}) as an input parameter of the time sequence analysis model, wherein W_{R} is the position of the human, W_{R} ∈[W₁, W₂, . . . Wₙ], Wₙ is the position coordinate of the human at time n; Z_{R} is the posture of the human, Z_{R}∈[Z₁, Z₂, . . . Zₙ], Zₙ is the attitude coordinates of the human on both arms at time n.

Accordingly, by inputting the time sequence analysis model in the above-described binary group, the attack behavior of the human can be accurately predicted. Wherein the threshold G_{L} of the present embodiment is set to 65.5%, and when G_{R}=60%, G_{R}<G_{L}, then the human has no dangerous attack behavior; when G_{R}=70%, G_{R}>G_{L}, then the human has dangerous attack behavior.

When the living organism is an animal, the determination of the dangerous attack behavior is based on the following:

step S301, extracting a plurality of video frames of an animal limb action in video information at intervals of a pre-set time of 5 seconds, identifying positions and gestures of the animal in the pluralities of video frames, then calculating an attack probability G_{R′} of the animal attacking the protected object according to the relevant information about the positions and gestures of the animal by a time sequence analysis model, and judging whether the attack probability G_{R′} reaches a threshold value G_{L′}, wherein if G_{R′} [symbol] G_{L′}, the animal has a dangerous attack behaviour, and if G_{R′}<G_{L′}, the animal does not have the dangerous attack behaviour;

step S302, and/or extracting a plurality of video frames of the animal facial micro-expression in the video information at intervals of a pre-set time of 5 seconds, matching the animal facial micro-expression images corresponding to the pluralities of video frames with a plurality of animal aggressive images pre-stored in the risk analysis database, then performing matching degree analysis on the animal facial micro-expression images corresponding to the pluralities of video frames with the matching selected animal aggressive images so as to obtain a numerical value of a matching degree P_{A}, and then judging whether the matching degree P_{A} reaches a threshold value P_{L}, wherein if P_{A} [symbol] P_{L}, then the animal has a dangerous attack behaviour, and if P_{A}<P_{L}, then the animal does not have the dangerous attack behaviour.

It should be noted that the dangerous attack behaviour of the animal itself can also be measured through its facial micro-expression, such as a puppy. When the forehead of the puppy is suddenly wrinkled, then the puppy is in an angry state and has a dangerous attack behaviour; alternatively, when the puppy uncovers the teeth, it is also a dangerous micro-expression signal, whether the lips are fully extended forward or backward, which is a dangerous attack behaviour.

Preferably, the calculation of the attack probability G_{R′} comprises:

Using a binary group (W_{R′}, Z_{R′}) as an input parameter of the time sequence analysis model, wherein W_{R′} is the position of the animal, W_{R′}∈[W₁, W₂, . . . W_{n′}], W_{n′} is the position coordinate of the animal at time n′; Z_{R′} is the posture of the animal, Z_{R′}∈[Z₁, Z₂, . . . Z_{n′}], Z_{n′} is the attitude coordinates of the animal on both arms at time n′.

Accordingly, by inputting the time sequence analysis model in the above-described binary group, the attack behavior of the animal can be accurately predicted. Wherein the threshold G_{L′} of the present embodiment is set to 63.5%, and when G_{R′}=60%, G_{R′}<G_{L′}, then the animal has no dangerous attack behavior; when G_{R′}=70%, G_{R′}>G_{L′}, then the animal has dangerous attack behavior.

### Second Embodiment

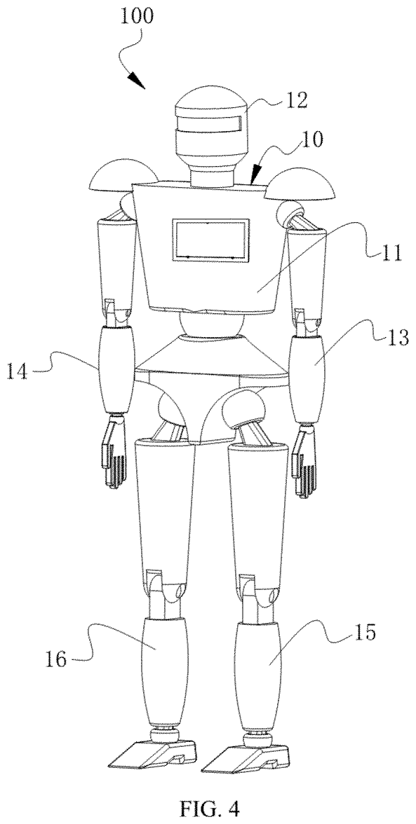

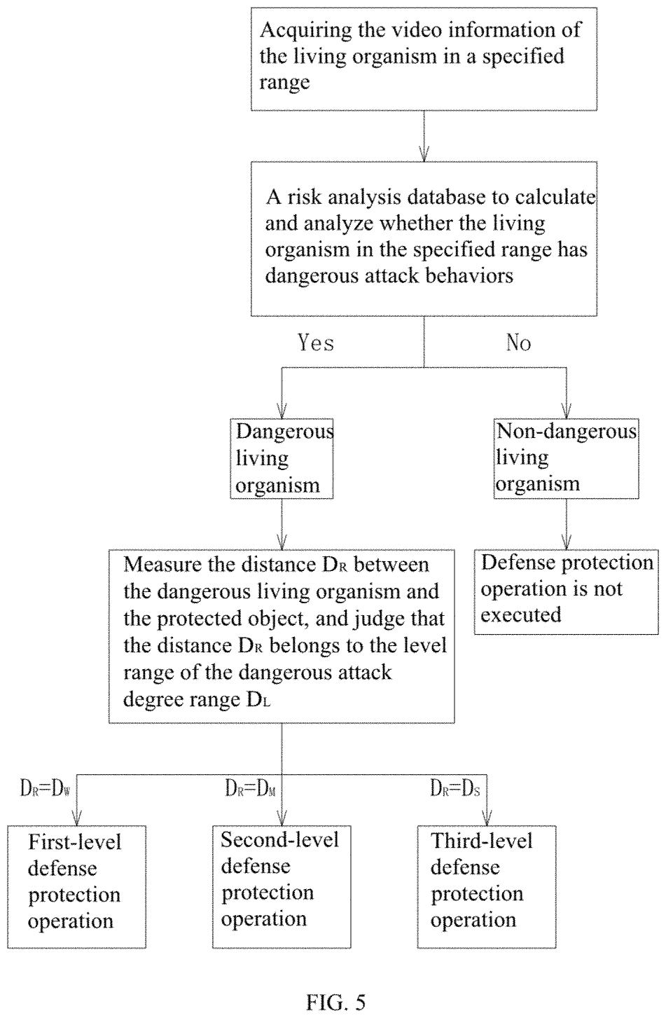

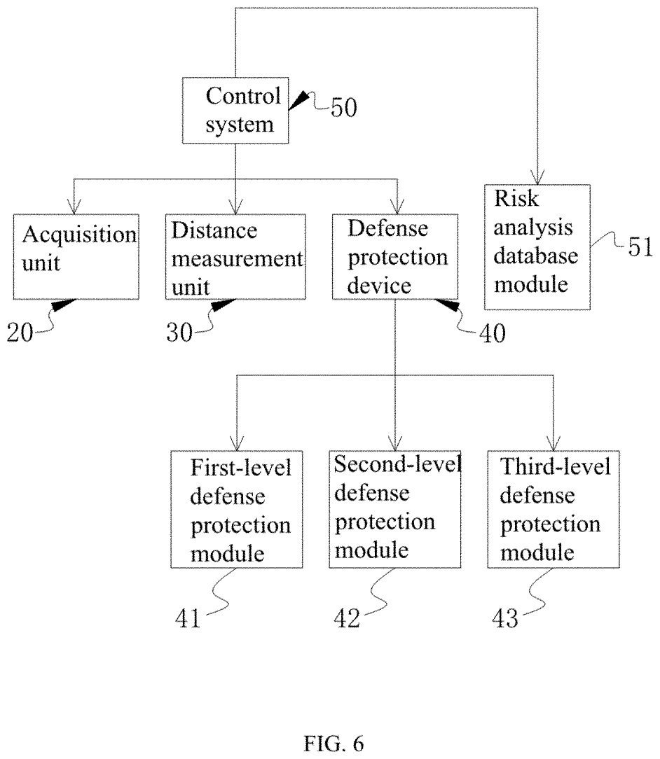

Referring to FIGS. 4 to 6, there is another preferred embodiment of the present invention, which relates to an intelligent dart protection robot 100, comprising a robot body 10, an acquisition unit 20, a distance measurement unit 30, a defense protection device 40 and a control system 50, and the parts of the intelligent dart protection robot 100 are further described below:

the robot body 10 comprises a body 11, a head 12, a left arm 13, a right arm 14, a left leg 15 and a right leg 16, wherein the head 12 is rotatably arranged at the upper end of the body 11, the left arm 13 is movably arranged at one side end of the body 11, the right arm 14 is movably arranged at the other side end of the body 11, and the left leg 15 is movably arranged at one side end of the lower end of the body 11, the right leg 16 is movably arranged on the other side end of the lower end of the body 11;

the acquisition unit 20 is arranged in the head 12 and used for acquiring the video information of the living organism in a specified range; the video information comprises limb action information and facial micro-expression information;

the distance measurement unit 30 is arranged in the head 12 and used for measuring the distance D_{R} between the dangerous living organism and the protected object, then substituting the distance D_{R} into the set dangerous attack degree range D_{L}, and judging that the distance D_{R} belongs to the level range of the dangerous attack degree range D_{L}; the dangerous attack degree range D_{L} comprises a weak attack danger range D_{W}, a medium attack danger range D_{M} and a serious attack danger range D_{S}, D_{W}≥D_{M}≥D_{S}, D_{R}∈[D_{W}, D_{M}, D_{S}];

the defense protection device 40 is arranged on the robot body 10 and used for executing the corresponding defense protection operation according to the level range of the distance D_{R} within the dangerous attack degree range D_{L}; the defense protection device 40 comprises a first-level defense protection module 41 used for warning prompt, a second-level defense protection module 42 used for protecting the object and warning the dangerous living organism, and a third-level defense protection module 43 used for protecting the object and stimulating to retreat the dangerous living organism, when the distance D_{R} belongs to the weak attack danger range D_{W}, the first-level defense protection module 41 executes the first-level defense protection operation, when the distance D_{R} belongs to the medium attack danger range D_{M}, the second-level defense protection module 42 executes the second-level defense protection operation, and when the distance D_{R} belongs to the serious attack danger range D_{S}, the third-level defense protection module 43 executes the third-level defense protection operation; Specifically, wherein the first-level defense protection module 41 comprises a warning device capable of warning a living organism and/or a protected object, the second-level defense protection module 42 comprises a protection shield for protecting the protected object and a high decibel alarm device, the protection shield is foldably provided on the left arm 13 and/or the right arm 14 of the robot body 10, and the third-level defense protection module 43 comprises a spicy spray appliance and an electric pulse capable of generating a strong current;

the control system 50 is arranged inside the body 11 and is respectively connected with the acquisition unit 20, the distance measurement unit 30 and the defense protection device 40, and used for controlling the acquisition unit 20, the distance measurement unit 30 and the defense protection device 40 to work; the control system 50 includes a risk analysis database module 51 for calculating and analyzing whether the living organism in the specified range has dangerous attack behaviors, defining the living organism analyzed for the existence of the dangerous attack behaviors as a dangerous living organism, and defining the living organism analyzed for the absence of the dangerous attack behaviors as a non-dangerous living organism.

Accordingly, the video information of the living organism is continuously collected in a specified range by the acquisition unit 20, specifically, limb motion information and facial micro-expression information of the living organism are analyzed; then, the acquisition unit 20 would transmit the collected video information to the risk analysis database module 51 of the control system 50 to calculate and analyze whether the living organism within the specified range has a dangerous attack behavior, and define the living organism analyzed for the existence of the dangerous attack behaviors as a dangerous living organism, and define the living organism analyzed for the absence of the dangerous attack behaviors as a non-dangerous living organism; when the living organism is determined to be a dangerous living organism, the distance measurement unit 30 performs a distance measurement operation on the dangerous living organism, so as to measure that the distance D_{R} between the dangerous living organism and the protected object is within the belonging range of the dangerous attack degree range D_{L}; in addition, according to the distance D_{R} between the dangerous living organism and the protected object, the defense protection device 40 performs the defense protection operation of the corresponding level in the level range of the dangerous attack degree range D_{L}, thereby avoiding the problem of improper defense or heavy defense.

In this way, for a sudden attack, an appropriate defense operation can be timely reflected and executed, so that the object can be timely protected and the attacker can be effectively knocked back. Meanwhile, potential dangerous persons and dangerous animals can be quickly and accurately identified, so that the defense protection operation can be carried out early, and attack and injury are effectively avoided.

Referring to FIGS. 2 to 3, when the living organism is a human, the determination of the dangerous attack behavior is based on the following:

step S201′, extracting a plurality of video frames of a human limb action in video information at intervals of a pre-set time of 5 seconds, identifying positions and gestures of the human in the plurality of video frames, then calculating an attack probability G_{R} of the human attacking the protected object according to the relevant information about the positions and gestures of the human by a time sequence analysis model, and judging whether the attack probability G_{R} reaches a threshold value G_{L}, wherein if G_{R} [symbol] G_{L}, the human has a dangerous attack behaviour, and if G_{R}<G_{L}, the human does not have the dangerous attack behaviour;

step S202′, and/or extracting a plurality of video frames of a human facial micro-expression in the video information at intervals of a pre-set time of 5 seconds, substituting relevant information about the human facial micro-expression of the pluralities of video frames into a pre-set calculation formula of an attack degree D_{A} so as to acquire a numerical value of the attack degree D_{A}, and then judging whether the attack degree D_{A} reaches a threshold value D_{L}, wherein if D_{A} [symbol] D_{L}, the human has a dangerous attack behaviour, and if D_{A}<D_{L}, the human does not have the dangerous attack behaviour, wherein the calculation formula of the attack degree D_{A} in the facial micro-expression is:

$${D}_{A} = \frac{1}{2} [ \frac{{F}_{M} + 4 \times \sqrt{\frac{1}{N}} {\sum }_{1}^{N} {( {F}_{i} - \overline{F} )}^{2}}{2 F i n} + \frac{\frac{{\sum }_{1}^{k} ( \frac{\vert {A}_{L}^{i} - {A}_{R}^{i} \vert}{{A}_{max}^{i}} + \frac{\vert {F}_{L}^{i} - {F}_{R}^{i} \vert}{{F}_{max}^{i}} )}{2 n} + \frac{{{\sum }^{{f}_{max}}}_{\frac{{f}_{max} + {f}_{min}}{2}} {P}_{i} ( f )}{{\sum }_{0 , 1}^{{f}_{max}} {P}_{i} ( f )}}{2} ]$$

F_{M} is the maximum frequency of the frequency distribution density histogram;

Fᵢ is obtaining a statistical calculation number of the frequency number of the histogram i of the frequency distribution density for 50 frames per time period;

Fin is the vibration image processing frequency; N is 50 frames and there is also a high limit value for the statistical calculation of the difference between frames;

A_{L}ⁱ is the total amplitude of the “I” thermal vibration image of the left part of the target;

A_{R}ⁱ is the total amplitude of the “I” thermal vibration image of the right part of the target;

Aₘₐₓⁱ−A_{L}ⁱ is the maximum value from start to A_{R}ⁱ;

F_{L}ⁱ is the maximum frequency of the “I” vibration image of the left part of the target;

F_{R}ⁱ is the maximum frequency of the “I” thermal vibration image of the right part of the target;

Fₘₐₓⁱ−F_{L}ⁱ is the maximum value from start to F_{R}ⁱ;

n is the maximum target heating value;

Pᵢ(f) is the vibration image frequency diffusion dynamic spectrum;

fₘₐₓ is the maximum frequency of frequency diffusion spectrum of vibration image;

fₘᵢₙ is the vibration image frequency spread spectrum minimum frequency.

Wherein the threshold value D_{L} of the present embodiment is set to 65.5%, and when D_{A}=60%, D_{A}<D_{L}, then the human has no dangerous attack behavior; and when D_{A}=70%, D_{A}>D_{L}, then the human has dangerous attack behavior.

Preferably, the calculation of the attack probability G_{R} comprises:

Using a binary group (W_{R}, Z_{R}) as an input parameter of the time sequence analysis model, wherein W_{R} is the position of the human, W_{R}∈[W₁, W₂, . . . Wₙ], Wₙ is the position coordinate of the human at time n; Z_{R} is the posture of the human, Z_{R}∈[Z₁, Z₂, . . . Zₙ], Zₙ is the attitude coordinates of the human on both arms at time n.

Accordingly, by inputting the time sequence analysis model in the above-described binary group, the attack behavior of the human can be accurately predicted. Wherein the threshold G_{L} of the present embodiment is set to 65.5%, and when G_{R}=60%, G_{R}<G_{L}, then the human has no dangerous attack behavior; when G_{R}=70%, G_{R}>G_{L}, then the human has dangerous attack behavior.

When the living organism is an animal, the determination of the dangerous attack behavior is based on the following:

step S301′, extracting a plurality of video frames of an animal limb action in video information at intervals of a pre-set time of 5 seconds, identifying positions and gestures of the animal in the pluralities of video frames, then calculating an attack probability G_{R′} of the animal attacking the protected object according to the relevant information about the positions and gestures of the animal by a time sequence analysis model, and judging whether the attack probability G_{R′} reaches a threshold value G_{L′}, wherein if G_{R′} [symbol] G_{L′}, the animal has a dangerous attack behaviour, and if G_{R′}<G_{L′}, the animal does not have the dangerous attack behaviour;

step S302′, and/or extracting a plurality of video frames of the animal facial micro-expression in the video information at intervals of a pre-set time of 5 seconds, matching the animal facial micro-expression images corresponding to the pluralities of video frames with a plurality of animal aggressive images pre-stored in the risk analysis database, then performing matching degree analysis on the animal facial micro-expression images corresponding to the pluralities of video frames with the matching selected animal aggressive images so as to obtain a numerical value of a matching degree P_{A}, and then judging whether the matching degree P_{A} reaches a threshold value P_{L}, wherein if P_{A} [symbol] P_{L}, then the animal has a dangerous attack behaviour, and if P_{A}<P_{L}, then the animal does not have the dangerous attack behaviour.

Preferably, the calculation of the attack probability G_{R′} comprises:

Using a binary group (W_{R′}, Z_{R′}) as an input parameter of the time sequence analysis model, wherein W_{R′} is the position of the animal, W_{R}∈[W₁, W₂, . . . Wₙ], W_{n′} is the position coordinate of the animal at time n′; Z_{R′} is the posture of the animal, Z_{R}∈[Z₁, Z₂, . . . Zₙ], Z_{n′} is the attitude coordinates of the animal on both arms at time n′.

Accordingly, by inputting the time sequence analysis model in the above-described binary group, the attack behavior of the animal can be accurately predicted. Wherein the threshold G_{L′} of the present embodiment is set to 63.5%, and when G_{R′}=60%, G_{R′}<G_{L′}, then the animal has no dangerous attack behavior; when G_{R′}=70%, G_{R′}>G_{L′}, then the animal has dangerous attack behavior.

The above-described embodiments are merely illustrative of the technical solutions of the present application and are not intended to be limiting thereof; although the present application has been described in detail with reference to the foregoing embodiments, those skilled in the art will appreciate that: the technical solutions of the above-mentioned embodiments can still be modified, or some of the technical features thereof can be equivalently replaced; such modifications and substitutions do not depart from the spirit and scope of the embodiments of the present invention, and are intended to be included within the scope of this application.

What is claimed is:

1. An intelligent defense protection method, comprises the following steps:
acquiring the video information of the living organism in a specified range, wherein the video information comprises limb action information and facial micro-expression information;
inputting the collected video information of the living organism into a risk analysis database to calculate and analyze whether the living organism in the specified range has dangerous attack behaviors, defining the living organism analyzed for the existence of the dangerous attack behaviors as a dangerous living organism, and defining the living organism analyzed for the absence of the dangerous attack behaviors as a non-dangerous living organism;
if the living organism is judged to be a non-dangerous living organism, a defense protection operation is not executed;
if the living organism is judged to be a dangerous living organism, a distance measuring operation is performed to measure the distance D_{R} between the dangerous living organism and the protected object, then the distance D_{R} is substituted into the set dangerous attack degree range D_{L}, and it is determined that the distance D_{R} belongs to the level range of the dangerous attack degree range D_{L};
executing the corresponding defense protection operation according to the level range of the distance D_{R} within the dangerous attack degree range D_{L};
wherein the dangerous attack degree range D_{L} comprises a weak attack danger range D_{W}, a medium attack danger range D_{M} and a serious attack danger range D_{S}, D_{W}≥D_{M}≥D_{S}, D_{R}∈[D_{W}, D_{M}, D_{S}];
the defense protection operation comprises a first-level defense protection operation for warning prompt, a second-level defense protection operation for protecting the object and warning the dangerous living organism, and a third-level defense protection operation for protecting the object and stimulating to retreat the dangerous living organism;
if the distance D_{R} belongs to the weak attack danger range D_{W}, executing the first-level defense protection operation;
if the distance D_{R} belongs to the medium attack danger range D_{M}, executing the second-level defense protection operation;
if the distance D_{R} belongs to the serious attack danger range D_{S}, executing the third-level defense protection operation.

2. The intelligent defense protection method according to claim 1, wherein when the living organism is a human, the determination of the dangerous attack behavior is based on the following:
extracting a plurality of video frames of a human limb action in video information at intervals of a pre-set time of 5 seconds, identifying positions and gestures of the human in the pluralities of video frames, then calculating an attack probability G_{R} of the human attacking the protected object according to the relevant information about the positions and gestures of the human by a time sequence analysis model, and judging whether the attack probability G_{R} reaches a threshold value G_{L}, wherein if G_{R} [symbol] G_{L}, the human has a dangerous attack behaviour, and if G_{R}<G_{L}, the human does not have the dangerous attack behaviour;
and/or extracting a plurality of video frames of a human facial micro-expression in the video information at intervals of a pre-set time of 5 seconds, substituting relevant information about the human facial micro-expression of the pluralities of video frames into a pre-set calculation formula of an attack degree D_{A} so as to acquire a numerical value of the attack degree D_{A}, and then judging whether the attack degree D_{A} reaches a threshold value D_{L}, wherein if D_{A} [symbol] D_{L}, the human has a dangerous attack behaviour, and if D_{A}<D_{L}, the human does not have the dangerous attack behaviour, wherein the calculation formula of the attack degree D_{A} in the facial micro-expression is:
$${D}_{A} = \frac{1}{2} [ \frac{{F}_{M} + 4 \times \sqrt{\frac{1}{N}} {\sum }_{1}^{N} {( {F}_{i} - \overline{F} )}^{2}}{2 F i n} + \frac{\frac{{\sum }_{1}^{k} ( \frac{\vert {A}_{L}^{i} - {A}_{R}^{i} \vert}{{A}_{max}^{i}} + \frac{\vert {F}_{L}^{i} - {F}_{R}^{i} \vert}{{F}_{max}^{i}} )}{2 n} + \frac{{{\sum }^{{f}_{max}}}_{\frac{{f}_{max} + {f}_{min}}{2}} {P}_{i} ( f )}{{\sum }_{0 , 1}^{{f}_{max}} {P}_{i} ( f )}}{2} ]$$
F_{M} is the maximum frequency of the frequency distribution density histogram;
Fᵢ is obtaining a statistical calculation number of the frequency number of the histogram i of the frequency distribution density for 50 frames per time period;
Fin is the vibration image processing frequency;
N is 50 frames and there is also a high limit value for the statistical calculation of the difference between frames;
A_{L}ⁱ is the total amplitude of the “I” thermal vibration image of the left part of the target;
A_{R}ⁱ is the total amplitude of the “I” thermal vibration image of the right part of the target;
Aₘₐₓⁱ−A_{L}ⁱ is the maximum value from start to A_{R}ⁱ;
F_{L}ⁱ is the maximum frequency of the “I” vibration image of the left part of the target;
F_{R}ⁱ is the maximum frequency of the “I” thermal vibration image of the right part of the target;
Fₘₐₓⁱ−F_{L}ⁱ is the maximum value from start to F_{R}ⁱ;
n is the maximum target heating value;
Pᵢ(f) is the vibration image frequency diffusion dynamic spectrum;
fₘₐₓ is the maximum frequency of frequency diffusion spectrum of vibration image;
fₘᵢₙ is the vibration image frequency spread spectrum minimum frequency.

3. The intelligent defense protection method according to claim 2, wherein the calculation of the attack probability G_{R} comprises:
Using a binary group (W_{R}, Z_{R}) as an input parameter of the time sequence analysis model, wherein W_{R} is the position of the human, W_{R}∈[W₁, W₂, . . . Wₙ], Wₙ is the position coordinate of the human at time n; Z_{R} is the posture of the human, Z_{R}∈[Z₁, Z₂, . . . Zₙ], Zₙ is the attitude coordinates of the human on both arms at time n.

4. The intelligent defense protection method according to claim 1, wherein when the living organism is an animal, the determination of the dangerous attack behavior is based on the following:
extracting a plurality of video frames of an animal limb action in video information at intervals of a pre-set time of 5 seconds, identifying positions and gestures of the animal in the pluralities of video frames, then calculating an attack probability G_{R′} of the animal attacking the protected object according to the relevant information about the positions and gestures of the animal by a time sequence analysis model, and judging whether the attack probability G_{R′} reaches a threshold value G_{L′}, wherein if G_{R′} [symbol] G_{L′}, the animal has a dangerous attack behaviour, and if G_{R′}<G_{L′}, the animal does not have the dangerous attack behaviour;
and/or extracting a plurality of video frames of the animal facial micro-expression in the video information at intervals of a pre-set time of 5 seconds, matching the animal facial micro-expression images corresponding to the pluralities of video frames with a plurality of animal aggressive images pre-stored in the risk analysis database, then performing matching degree analysis on the animal facial micro-expression images corresponding to the pluralities of video frames with the matching selected animal aggressive images so as to obtain a numerical value of a matching degree P_{A}, and then judging whether the matching degree P_{A} reaches a threshold value P_{L}, wherein if P_{A} [symbol] P_{L}, then the animal has a dangerous attack behaviour, and if P_{A}<P_{L}, then the animal does not have the dangerous attack behaviour.

5. The intelligent defense protection method according to claim 4, wherein the calculation of the attack probability G_{R′} comprises:
Using a binary group (W_{R′}, Z_{R′}) as an input parameter of the time sequence analysis model, wherein W_{R′} is the position of the animal, W_{R}∈[W₁, W₂, . . . Wₙ], W_{n′} is the position coordinate of the animal at time n′; Z_{R′} is the posture of the animal, Z_{R}∈[Z₁, Z₂, . . . Zₙ], Z_{n′} is the attitude coordinates of the animal on both arms at time n′.

6. An intelligent dart protection robot, which comprises:
a robot body comprises a body, a head, a left arm, a right arm, a left leg and a right leg, wherein the head is rotatably arranged at the upper end of the body, the left arm is movably arranged at one side end of the body, the right arm is movably arranged at the other side end of the body, and the left leg is movably arranged at one side end of the lower end of the body, the right leg is movably arranged on the other side end of the lower end of the body;
an acquisition unit is arranged in the head and used for acquiring the video information of the living organism in a specified range; the video information comprises limb action information and facial micro-expression information;
a distance measurement unit is arranged in the head and used for measuring the distance D_{R} between the dangerous living organism and the protected object, then substituting the distance D_{R} into the set dangerous attack degree range D_{L}, and judging that the distance D_{R} belongs to the level range of the dangerous attack degree range D_{L}; the dangerous attack degree range D_{L} comprises a weak attack danger range D_{W}, a medium attack danger range D_{M} and a serious attack danger range D_{S}, D_{W}≥D_{M}≥D_{S}, D_{R}∈[D_{W}, D_{M}, D_{S}];
a defense protection device is arranged on the robot body and used for executing the corresponding defense protection operation according to the level range of the distance D_{R} within the dangerous attack degree range D_{L}; the defense protection device comprises a first-level defense protection module used for warning prompt, a second-level defense protection module used for protecting the object and warning the dangerous living organism, and a third-level defense protection module used for protecting the object and stimulating to retreat the dangerous living organism, when the distance D_{R} belongs to the weak attack danger range D_{W}, the first-level defense protection module executes the first-level defense protection operation, when the distance D_{R} belongs to the medium attack danger range D_{M}, the second-level defense protection module executes the second-level defense protection operation, and when the distance D_{R} belongs to the serious attack danger range D_{S}, the third-level defense protection module executes the third-level defense protection operation;
a control system is arranged inside the body and is respectively connected with the acquisition unit, the distance measurement unit and the defense protection device, and used for controlling the acquisition unit, the distance measurement unit and the defense protection device to work; the control system includes a risk analysis database module for calculating and analyzing whether the living organism in the specified range has dangerous attack behaviors, defining the living organism analyzed for the existence of the dangerous attack behaviors as a dangerous living organism, and defining the living organism analyzed for the absence of the dangerous attack behaviors as a non-dangerous living organism.

7. The intelligent dart protection robot according to claim 6, wherein when the living organism is a human, the determination of the dangerous attack behavior is based on the following:
extracting a plurality of video frames of a human limb action in video information at intervals of a pre-set time of 5 seconds, identifying positions and gestures of the human in the pluralities of video frames, then calculating an attack probability G_{R} of the human attacking the protected object according to the relevant information about the positions and gestures of the human by a time sequence analysis model, and judging whether the attack probability G_{R} reaches a threshold value G_{L}, wherein if G_{R} [symbol] G_{L}, the human has a dangerous attack behaviour, and if G_{R}<G_{L}, the human does not have the dangerous attack behaviour;
and/or extracting a plurality of video frames of a human facial micro-expression in the video information at intervals of a pre-set time of 5 seconds, substituting relevant information about the human facial micro-expression of the pluralities of video frames into a pre-set calculation formula of an attack degree D_{A} so as to acquire a numerical value of the attack degree D_{A}, and then judging whether the attack degree D_{A} reaches a threshold value D_{L}, wherein if D_{A} [symbol] D_{L}, the human has a dangerous attack behaviour, and if D_{A}<D_{L}, the human does not have the dangerous attack behaviour, wherein the calculation formula of the attack degree D_{A} in the facial micro-expression is:
$${D}_{A} = \frac{1}{2} [ \frac{{F}_{M} + 4 \times \sqrt{\frac{1}{N}} {\sum }_{1}^{N} {( {F}_{i} - \overline{F} )}^{2}}{2 F i n} + \frac{\frac{{\sum }_{1}^{k} ( \frac{\vert {A}_{L}^{i} - {A}_{R}^{i} \vert}{{A}_{max}^{i}} + \frac{\vert {F}_{L}^{i} - {F}_{R}^{i} \vert}{{F}_{max}^{i}} )}{2 n} + \frac{{{\sum }^{{f}_{max}}}_{\frac{{f}_{max} + {f}_{min}}{2}} {P}_{i} ( f )}{{\sum }_{0 , 1}^{{f}_{max}} {P}_{i} ( f )}}{2} ]$$
F_{M} is the maximum frequency of the frequency distribution density histogram;
Fᵢ is obtaining a statistical calculation number of the frequency number of the histogram i of the frequency distribution density for 50 frames per time period;
Fin is the vibration image processing frequency;
N is 50 frames and there is also a high limit value for the statistical calculation of the difference between frames;
A_{L}ⁱ is the total amplitude of the “I” thermal vibration image of the left part of the target;
A_{R}ⁱ is the total amplitude of the “I” thermal vibration image of the right part of the target;
Aₘₐₓⁱ−A_{L}ⁱ is the maximum value from start to A_{R}ⁱ;
F_{L}ⁱ is the maximum frequency of the “I” vibration image of the left part of the target;
F_{R}ⁱ is the maximum frequency of the “I” thermal vibration image of the right part of the target;
Fₘₐₓⁱ−F_{L}ⁱ is the maximum value from start to F_{R}ⁱ;
n is the maximum target heating value;
Pᵢ(f) is the vibration image frequency diffusion dynamic spectrum;
fₘₐₓ is the maximum frequency of frequency diffusion spectrum of vibration image;
fₘᵢₙ is the vibration image frequency spread spectrum minimum frequency.

8. The intelligent dart protection robot according to claim 7, wherein the calculation of the attack probability G_{R} comprises:
Using a binary group (W_{R}, Z_{R}) as an input parameter of the time sequence analysis model, wherein W_{R} is the position of the human, W_{R}∈[W₁, W₂, . . . Wₙ], Wₙ is the position coordinate of the human at time n; Z_{R} is the posture of the human, Z_{R}∈[Z₁, Z₂, . . . Zₙ], Zₙ is the attitude coordinates of the human on both arms at time n.

9. The intelligent dart protection robot according to claim 6, wherein when the living organism is an animal, the determination of the dangerous attack behavior is based on the following:
extracting a plurality of video frames of an animal limb action in video information at intervals of a pre-set time of 5 seconds, identifying positions and gestures of the animal in the pluralities of video frames, then calculating an attack probability G_{R′} of the animal attacking the protected object according to the relevant information about the positions and gestures of the animal by a time sequence analysis model, and judging whether the attack probability G_{R′} reaches a threshold value G_{L′}, wherein if G_{R′} [symbol] G_{L′}, the animal has a dangerous attack behaviour, and if G_{R′}<G_{L′}, the animal does not have the dangerous attack behaviour;
and/or extracting a plurality of video frames of the animal facial micro-expression in the video information at intervals of a pre-set time of 5 seconds, matching the animal facial micro-expression images corresponding to the pluralities of video frames with a plurality of animal aggressive images pre-stored in the risk analysis database, then performing matching degree analysis on the animal facial micro-expression images corresponding to the pluralities of video frames with the matching selected animal aggressive images so as to obtain a numerical value of a matching degree P_{A}, and then judging whether the matching degree P_{A} reaches a threshold value P_{L}, wherein if P_{A} [symbol] P_{L}, then the animal has a dangerous attack behaviour, and if P_{A}<P_{L}, then the animal does not have the dangerous attack behaviour.

10. The intelligent dart protection robot according to claim 9, wherein the calculation of the attack probability G_{R′} comprises:
Using a binary group (W_{R′}, Z_{R′}) as an input parameter of the time sequence analysis model, wherein W_{R′} is the position of the animal, W_{R′}∈[W₁, W₂, . . . Wₙ], W_{n′} is the position coordinate of the animal at time n′; Z_{R′} is the posture of the animal, Z_{R′}∈[Z₁, Z₂, . . . Z_{n′}], R_{n′} is the attitude coordinates of the animal on both arms at time n′.
